(19) United States
(12) Patent Application Publication
(10) Pub. No.: US 2011/0011242 A1
(43) Pub. Date: Jan. 20, 2011

(54) APPARATUS AND METHOD FOR PROCESSING MUSIC DATA STREAMS

(76) Inventors: Michael Coyote, South Seattle, WA (US); Gary Wayne Thompson, Issaquah, WA (US)

Correspondence Address: COOLEY LLP;ATTN: Patent Group, Suite 1100, 777 - 6th Street, NW, WASHINGTON, DC, 20001, US

(21) Appl. No.: 12/502,825

(22) Filed: Jul. 14, 2009

(51) Int. Cl. G10H 7/00

(52) U.S. Cl. 84/604

(57) ABSTRACT

An apparatus comprises a data receiving module, a synthesizer module and a mix-in sample module. The data receiving module is configured to receive a plurality of Musical Instrument Digital Interface (MIDI) data signals. The synthesizer module is configured to analyze the plurality of MIDI data signals to generate a plurality of audio signals corresponding to the MIDI data signals. The synthesizer module includes a mix-in sample module. The mix-in sample module is configured to receive an original sample from a plurality of samples, select a mix-in sample for the original sample, determine a mix-in velocity percentage for the mix-in sample, alter the original sample based on the mix-in velocity percentage to generate an altered original sample and generate an altered audio signal based on the altered original sample and the mix-in velocity percentage.

### FIELD OF THE INVENTION

The present invention relates generally to processing music data streams and more particularly to an apparatus and method for analyzing Musical Instrument Digital Interface (MIDI) data signals to generate audio signals with enhanced acoustic characteristics such as greater variations in resonance, timbre and tone.

### BACKGROUND OF THE INVENTION

MIDI data signals provide a standardized format for representing musical performance information as electronic data. MIDI data signals typically include a binary representation of note sequences such as note number, note velocity, note duration and other metadata that comprise a complete musical composition. While a MIDI data signal includes information that determines the instrumentation and the duration of note values to be played, it typically does not specify the actual sound output in terms of quality. An audio processing tool generates audio signals from MIDI data signals by interpreting information in the MIDI data signal

One disadvantage of using MIDI data signals to represent musical performance information occurs when audio samples are triggered repeatedly at or around the same velocity. This typically results in a static and unrealistic reproduction of the musical performance. One way to address this issue is to use a round robin approach, which typically uses multiple samples on the same velocity layer by selecting one sample after another. This approach, however, generally does not work well unless large data sample sets are provided containing similarly sounding samples. It would be desirable to develop a technique by which enhanced acoustic characteristics such as resonance, timbre and tone in similarly sounding samples can be achieved. It would also be desirable to develop a technique by which enhanced acoustic characteristics such as resonance, timbre and tone can be achieved in small sample sets, such as those pertaining to legacy products and musical compositions.

### SUMMARY OF THE INVENTION

Embodiments of the invention relate to an apparatus comprising a data receiving module, a synthesizer module and a mix-in sample module. The data receiving module is configured to receive a plurality of Musical Instrument Digital Interface (MIDI) data signals. The synthesizer module is configured to analyze the plurality of MIDI data signals to generate a plurality of audio signals corresponding to the MIDI data signals. The synthesizer module includes a mix-in sample module. The mix-in sample module is configured to receive an original sample from the plurality of samples, select a mix-in sample for the original sample, determine a mix-in velocity percentage for the mix-in sample, alter the original sample based on the mix-in velocity percentage to generate an altered original sample and generate an altered audio signal based on the altered original sample and the mix-in velocity percentage.

In another embodiment, the invention relates to a computer readable storage medium. The computer readable storage medium includes executable instructions to receive a first MIDI data signal from a sequence of MIDI data signals and a second MIDI data signal from the sequence of MIDI data signals. The computer readable storage medium includes executable instructions to generate a first sample based on the first MIDI signal and generate a second sample based on the second MIDI data signal. The computer readable storage medium further includes executable instructions to select a mix-in sample for the second sample. In one embodiment, the MIDI note velocity associated with the first MIDI data signal and the MIDI note velocity associated with the second MIDI data signal are within a pre-determined velocity variation range. The computer readable storage medium includes executable instructions to alter the second sample based on the mix-in sample and a user-specified value to generate an altered second sample and generate an altered second audio signal based on the altered second sample and the mix-in sample.

In yet another embodiment, the invention relates to a computer system. The computer system comprises a processor and a memory connected to the processor. The memory stores executable instructions to receive an original sample from a plurality of samples, select a mix-in sample for the original sample, determine a mix-in velocity percentage for the mix-in sample, alter the original sample based on the mix-in velocity percentage to generate an altered original sample and generate an altered audio signal based on the altered original sample and the mix-in velocity percentage.

### BRIEF DESCRIPTION OF THE FIGURES

The invention is more fully appreciated in connection with the following detailed description taken in conjunction with the accompanying drawings, in which:

FIG. 1 illustrates a computer system configured in accordance with one embodiment of the present invention.

FIG. 2 illustrates exemplary velocity layers associated with a drum pad, in accordance with one embodiment of the present invention.

FIG. 3 is a graph illustrating an original sample, an added sample, a normalized percentage of the original sample and the computation of a percentage of the original sample retained, in accordance with one embodiment of the present invention.

Like reference numerals refer to corresponding parts throughout the several views of the drawings.

### DETAILED DESCRIPTION OF THE INVENTION

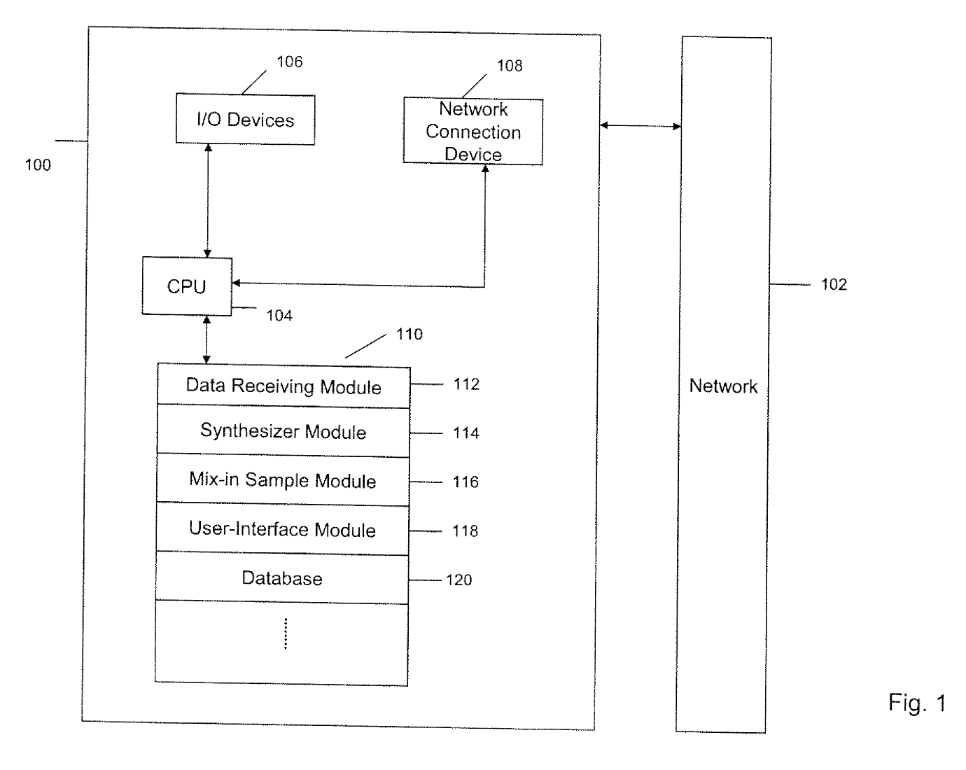

FIG. 1 illustrates a computer system 100 configured in accordance with one embodiment of the present invention. The computer system 100 includes various components such as a processor or a Central Processing Unit (“CPU”) 104 that is connected to a set (i.e., one or more) of input/output devices 106 (e.g., keyboard, mouse, video monitor, printer, speaker, and so forth), a network connection device 108 and a memory 110. The network connection device 108 provides connectivity to a network 102, thereby allowing the computer system 100 to operate in a networked environment. The various components can be standard components or can be configured for the processing described herein.

The memory 110 stores a set of executable modules for implementing the processing described herein. In one embodiment, the memory 110 includes a data receiving module 112, a synthesizer module 114, a mix-in sample module 116 and a user-interface module 118. The executable modules may be implemented in hardwired circuitry, in one embodiment. In another embodiment, the executable modules in the memory 110 may be implemented with machine-executable software instructions. In other embodiments, a combination of hardwired circuitry and machine-executable software instructions may also be used to implement the executable modules. In certain embodiments, and as illustrated in FIG. 1, the various executable modules in the memory 110 may also operate in conjunction with a database 120.

While the various modules 112, 114, 116 and 118 and the database 120 are shown residing in the single computer system 100, it should be recognized that such configuration is not required in all applications. For instance, one or more of the various modules 112, 114, 116 and 118 or the database 120 may reside in a separate computer system (not shown in FIG. 1) that is connected to the network 102. Also, one or more of the various modules 112, 114, 116 and 118 can be combined or sub-divided. In addition, while not shown in FIG. 1, a database management system (e.g., a conventional database management system) may be provided to create the database 120 as well as to facilitate access to the database 120 using the various modules 112, 114, 116 and 118. Moreover, while not shown in FIG. 1, an audio processing tool can be used instead of or in conjunction with, the synthesizer module 114 to produce audio output and perform a variety of audio processing functions. The operations performed by the executable modules 112, 114, 116 and 118 are discussed in greater detail below.

The data receiving module 112 is configured to receive a plurality of MIDI data signals. In one embodiment, the MIDI data signals may originate from a MIDI controller, a MIDI sequencer or a Digital Audio Workstation (DAW) (not shown in FIG. 1) connected to the data receiving module 112. As used herein, a “MIDI controller” typically refers to a device which is played as an instrument and translates a musical performance into MIDI data signals. In another embodiment, the data receiving module 112 may also be configured to receive the plurality of MIDI data signals based on a set of MIDI data patterns and MIDI data grooves stored in the database 120. In a particular embodiment, the plurality of MIDI data signals may be generated by analyzing drum beats that originate from a MIDI drum controller. The MIDI data signals may also be generated based on analyzing the set of MIDI drum patterns and MIDI drum grooves stored in the database 120. While the disclosed embodiments describe an apparatus and method to analyze data samples that relate to the musical performance of a percussion instrument, such as a MIDI drum controller, it is to be appreciated that the disclosed embodiments can be applied to analyze data samples generated using various other musical instruments.

As will be appreciated by those skilled in the art, a MIDI data signal having a high velocity value (i.e., a high MIDI note velocity) typically results in the generation of a louder audio signal. For example, in the case of a MIDI drum controller which typically comprises six to eight drum pads, the MIDI note velocity corresponds to the intensity with which a particular drum pad is struck. A single drum pad hit may be mapped to a specific MIDI note velocity and/or to one or more MIDI velocity layers. For example, hitting the drum pad at velocities ranging from (0-64) may generate a sample of a drum pad hit that was struck softly, while hitting the drum pad at velocities ranging from (65-127) typically generates a sample of a drum pad hit that was struck hard.

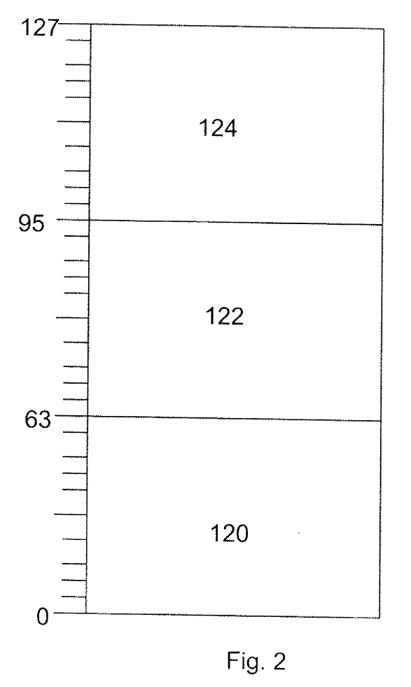

FIG. 2 illustrates exemplary velocity layers associated with a drum pad, in accordance with one embodiment of the present invention. The exemplary illustration in FIG. 2 shows a drum pad with three velocity layers, 120, 122 and 124 having MIDI note velocity ranges, (0-63), (64-95) and (96-127) respectively. However, it is to be appreciated that each drum pad may be assigned to several MIDI velocity layers with a range of MIDI note velocities. In one embodiment, each drum pad may be assigned a minimum of three velocity layers and a maximum of fifty velocity layers. In accordance with embodiments of the present invention, the data receiving module 112 is configured to receive a plurality of MIDI note velocities associated with the plurality of MIDI data signals. The synthesizer module 114 is configured to analyze the plurality of MIDI data signals to generate a plurality of audio signals corresponding to the MIDI data signals. In one embodiment, the synthesizer module 114 is configured to generate a sample corresponding to an incoming MIDI data signal by mapping the MIDI note velocity associated with the MIDI data signal to one or more of the MIDI velocity layers 120, 122 and 124. As used herein, in one embodiment, the sample is referred to herein as an original sample. As will be discussed in greater detail below, the disclosed embodiments relate to a method and apparatus by which the original sample is processed to generate an altered audio signal with enhanced acoustic characteristics such as resonance, timbre and tone.

Returning to the discussion of FIG. 1, in one embodiment, the synthesizer module 114 includes a mix-in sample module 116. The mix-in sample module 116 is configured to receive the original sample from the synthesizer module 114 and select a mix-in sample for the original sample. In one embodiment, the mix-in sample module 116 is configured to select the mix-in sample for the original sample by identifying a plurality of candidate velocity layers that do not correspond to the velocity layer associated with the original sample. Referring to FIG. 2, in one example, if the original sample is mapped to the velocity layer 120, the velocity layer 122 or the velocity layer 124 may be used to select the mix-in sample for the original sample. In one embodiment, the selection of the mix-in sample is performed randomly. As used herein, and as will be discussed in greater detail below, the “mix-in sample” refers to a sample that is added to or mixed to the original sample. In one embodiment, the “mix-in sample” is referred to herein as an added sample.

In a particular embodiment, the mix-in sample module 116 is further configured to perform a plurality of processing operations on the mix-in sample. Specifically, the mix-in sample module 116 is configured to initially determine a mix-in velocity range for the mix-in sample. In one embodiment, the mix-in velocity range is a hard coded mix-in velocity range, that ranges from about 15% to about 60%, where the minimum mix-in percentage is about 15% and the maximum mix-in percentage is about 60%. The mix-in sample module 116 is further configured to decimate the mix-in velocity range to generate an altered mix-in velocity range as follows. The mix-in sample module 116 is configured to compute the velocity variation between the MIDI note velocity associated with the original sample and the MIDI note velocity associated with a MIDI data signal of an immediately preceding sample in the plurality of MIDI data signals. The mix-in sample module 116 is further configured to generate a percentage of normalized velocity variation as shown in equation (1) below:

Percentage of normalized velocity variation=1.0−(delta velocity/(maximum delta velocity*A)) (1)

In equation (1), delta velocity refers to the velocity variation between the consecutive MIDI note velocities, maximum delta velocity refers to the maximum possible velocity variation between consecutive MIDI note velocities and A is a constant. In one embodiment, the maximum delta velocity is in a range of values between 0 and 30 and the constant A is in a range of values between 0 and 10. For example, if the delta velocity=5, the maximum delta velocity=30 and the constant A=2, in one embodiment, an exemplary value of the percentage of normalized velocity variation may be computed as shown in equation (2) below:

Percentage of normalized velocity variation=1.0−(5/(30*2))=0.9167 (2)

The mix-in sample module 116 is then configured to compute an altered mix-in velocity value by scaling the mix-in velocity range by the percentage of normalized velocity variation, as shown in equation (3) below:

Altered mix-in velocity value=mix-in velocity range*percentage of normalized velocity variation (3)

In one embodiment, and as mentioned above, the mix-in velocity range ranges from about 15% to about 60%, with a minimum percentage value of about 15% and a maximum percentage value of about 60%. As will be appreciated by those skilled in the art a mix-in velocity range of about 15% to about 60% translates to an average mix-in velocity percentage of about 37.5%. By substituting the exemplary values of the mix-in velocity range and the percentage of normalized velocity variation determined as discussed above, an exemplary value of the altered mix-in velocity value may be computed as shown in equation (4) below:

Altered mix-in velocity value=37.5*0.9167=34.37 (4)

In another embodiment, the mix-in sample module 116 is further configured to compute a new maximum percentage value for the mix-in velocity range as shown in equation (5) below:

New maximum percentage value=Minimum percentage value+Altered mix-in velocity value (5)

By substituting the exemplary values generated in equation (4) above, an exemplary value of the new maximum percentage value may be computed as shown in equation (6) below:

New maximum percentage value=15+34.37=49.37 (6)

Based on the new maximum percentage value for the mix-in velocity range, the mix-in sample module 116 is configured to generate an altered mix-in velocity range for the mix-in sample. Observe that the altered mix-in velocity range now ranges from about 15% to about 49.37%, in one embodiment.

The mix-in sample module 116 is then configured to determine a mix-in velocity percentage for the mix-in sample by randomly selecting a value from the altered mix-in velocity range. For example, a randomly selected mix-in velocity percentage may have a value of 32%, in one embodiment, as shown in equation (7) below:

Mix-in velocity percentage=32% (7)

In another embodiment, the percentage of the mix-in sample to be added to the original sample may be farther varied based on a user-specified value. In a particular embodiment, the mix-in sample module 116 may be configured to alter the mix-in velocity percentage based on a user-specified value to generate an altered mix-in velocity percentage. In one embodiment, the user-interface module 118 in the computer system 100 is configured to receive, via a graphical user interface, the user-specified value. In a particular embodiment, the user-interface module 118 is configured to display a graphical slider in the graphical user interface, wherein the user-specified value is determined based on a particular position of the graphical slider within a range of values specified by the graphical slider. In one embodiment, the user-specified value may also be controlled by a user using the graphical user interface.

In one embodiment, the mix-in sample module 116 is configured to compute the altered mix-in velocity percentage based on the user-specified value as shown in equation (8) below:

Altered mix-in velocity percentage=mix-in velocity percentage+(maximum mix-in percentage value*normalized slider percentage value) (8)

In equation (8), the maximum mix-in percentage value refers to the maximum amount of the mix-in percentage that can be added to or mixed to the velocity layer associated with the original sample. In one example, the maximum mix-in percentage value is set to a value of 60. In one embodiment, the normalized slider percentage value is computed based on a particular position of the graphical slider as shown in equation (9) below:

Normalized slider percentage value=slider position/maximum slider position (9)

In one embodiment, the range of values specified by the graphical slider ranges from −50 to +50 and is normalized to a range of values between −1 and +1. For example a slider position having a value of 10 and a maximum slider position having a value of 50 results in the computation of a normalized slider percentage value of 0.2. Substituting the exemplary values generated for the mix-in velocity percentage, the maximum mix-in percentage value and the normalized slider percentage value results in the generation of an exemplary altered mix-in velocity percentage as shown in equation (10) below:

Altered mix-in velocity percentage=32+(60*0.2)=44% (10)

Observe that the randomly selected mix-in velocity percentage of 32% determined by the mix-in sample module 116 as discussed above is now further altered based on the user-specified value to result in the generation of an altered mix-in velocity percentage of 44% as shown in equation (10) above. As will be discussed in greater detail below, a percentage of the altered mix-in velocity percentage is used to generate the altered audio signal with enhanced acoustic characteristics.

In certain embodiments, the mix-in sample module 116 is further configured to determine a normalized altered mix-in velocity percentage as shown in equation (11) below:

Normalized altered mix-in velocity percentage=Altered mix-in velocity percentage/100 (11)

Substituting the exemplary value generated for the altered mix-in velocity percentage as shown in equation (10), an exemplary normalized altered mix-in velocity percentage may be computed as shown in equation (12) below:

Normalized altered mix-in velocity percentage=44/100=0.44 (12)

In certain embodiments, the velocity or volume of the original sample may further be altered based on the normalized altered mix-in velocity percentage as determined in equation (11) above. In one embodiment, the mix-in sample module 116 is initially configured to alter the velocity or volume of the original sample by decimating or attenuating the original sample based on the user-specified value. A percentage of the original sample retained is computed, as shown in equation (13) below:

Percentage of the original sample retained=1.0−(normalized slider percentage value*maximum possible decimation of the original sample) (13)

In one embodiment, the maximum possible decimation of the original sample is set to a value of 0.8. Substituting the exemplary values generated for the normalized slider percentage value and the maximum possible decimation of the original sample, an exemplary percentage of the original sample retained is computed as shown in equation (14) below:

Percentage of the original sample retained=1.0−(0.2*0.8)=0.84 (14)

In other words, in one embodiment, a large portion (i.e., 84%) of the original sample is retained to generate the altered audio signal. The mix-in sample module 116 is further configured to determine a normalized percentage of the original sample to be used in the generation of the altered audio signal based on the normalized altered mix-in velocity range as shown in equation (15) below:

Normalized percentage of the original sample=1.0−(normalized altered mix-in velocity percentage/B) (15)

In equation (15), B is a constant with a value=3.0, in one embodiment.

Substituting the exemplary values generated for the normalized altered mix-in velocity percentage and the constant B, an exemplary normalized percentage of the original sample may be computed as shown in equation (16) below:

Normalized percentage of the original sample=1.0−(0.44/3.0)=0.853 (16)

The mix-in sample module 116 is further configured to alter the normalized percentage of the original sample based on the slider position to generate a final normalized percentage of the original sample as shown in equation (17) below:

Final normalized percentage of the original sample=normalized percentage of the original sample*percentage of the original sample retained (17)

Substituting the exemplary values generated for the normalized percentage of the original sample and the percentage of the original sample retained, an exemplary final normalized percentage of the original sample may be computed as shown in equation (18) below:

Final normalized percentage of the original sample=0.853*0.84=0.7168 (18)

The mix-in sample module 116 is then configured to generate an altered audio signal based on the normalized altered mix-in velocity percentage computed as shown in equation (11) and the final normalized percentage of the original sample computed as shown in equation (17) above. Specifically, in one embodiment, the mix-in sample module 116 is configured to generate an altered added (i.e., mix-in) sample having an altered velocity (volume) by multiplying the added (i.e., mix-in) sample with the normalized altered mix-in velocity percentage. Similarly, the mix-in sample module 116 is configured to generate an altered original sample by multiplying the original sample with the final normalized percentage of the original sample. In another embodiment, the mix-in sample module 116 is configured to mix the altered original sample and the altered added (i.e., mix-in) sample to generate the altered audio signal with enhanced acoustic characteristics such as resonance, timber and tone. In such manner, the quality of the original sample is altered such that it sounds like a natural or realistic variation of the original sample, as though a drum pad was hit again but with subtle differences in terms of, for example, angle of the stick, strike position on the drum head, impact velocity and so forth.

Turning back to FIG. 1, in one embodiment, the synthesizer module 114 may be configured to generate the altered audio signal. In another embodiment, an audio processing tool (not shown in FIG. 1) coupled to the synthesizer module 114 may also be configured to generate and coordinate playback of the altered audio signal.

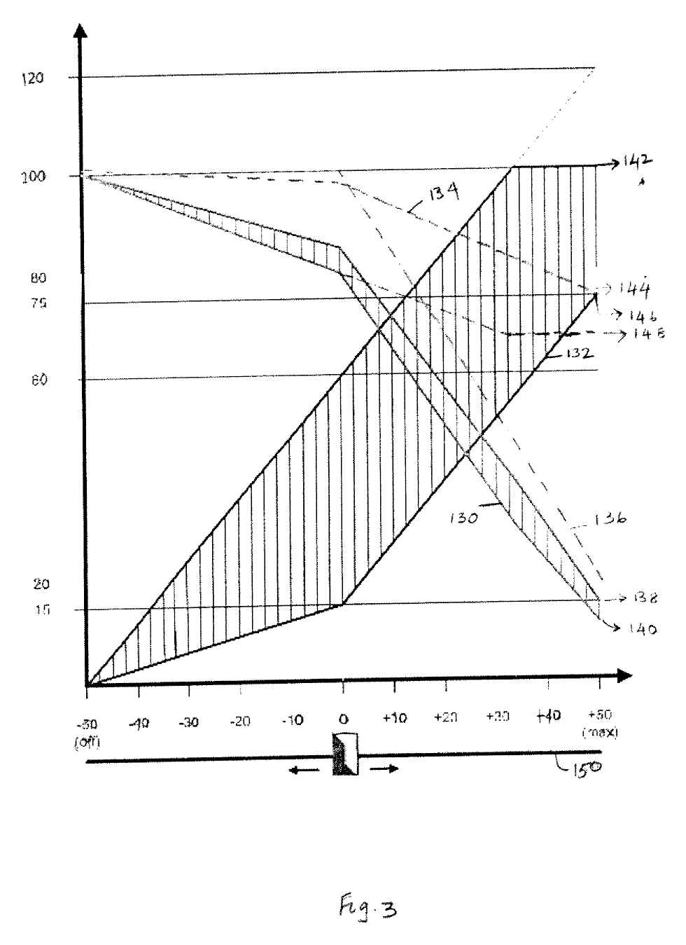

FIG. 3 is a graph illustrating an original sample, an added sample, a normalized percentage of the original sample and the computation of a percentage of the original sample retained, in accordance with one embodiment of the present invention. The original sample is represented by the reference numeral 130. The minimum percentage of the original sample is represented by the reference numeral 140 and the maximum percentage of the original sample is represented by the reference numeral 138. The added sample is represented by the reference numeral 132 with a minimum mix-in percentage value represented by the reference numeral 142 and a maximum mix-in percentage value represented by the reference numeral 144. The normalized percentage of the original sample is represented by the reference numeral 134 with lower and upper limits represented by reference numerals 146 and 148, respectively. The computation of the percentage of the original sample retained is determined based on the slider position as discussed above, and illustrated by the graphical curve, 136. An exemplary illustration of a graphical slider 150 is also shown in FIG. 3. While the single slider 150 is illustrated in FIG. 3, multiple sliders can also be included to enable the specification of the user-specified values, as discussed above.

In another embodiment, the data receiving module 112 includes executable instructions to receive a first MIDI data signal and a second MIDI data signal from a sequence of MIDI data signals. The mix-in sample module 116 includes executable instructions to compare the MIDI note velocities associated with the first MIDI data signal and the second MIDI data signal. If the MIDI note velocities associated with the first MIDI data signal and the second MIDI data signal are within a pre-determined velocity variation range, then executable instructions in the mix-in sample module 116 compute a mix-in sample for the second MIDI data signal. For example, in one embodiment, the pre-determined velocity variation range is between 0 to 5. The mix-in sample for the second MIDI data signal may be computed as discussed above. Similarly, and as discussed above, executable instructions in the mix-in sample module 116 further alter the sample corresponding to the second MIDI data signal based on a mix-in velocity percentage determined for the mix-in sample and the user-specified value to generate all altered second sample.

In a more specific embodiment, the data receiving module 112 further includes executable instructions to receive a third MIDI data signal and a fourth MIDI data signal from the sequence of MIDI data signals. In one embodiment, the first MIDI data signal, the second MIDI data signal, the third MIDI data signal and the fourth MIDI data signal correspond to consecutive MIDI data signals having the same note number in the sequence of MIDI data signals. The mix-in sample module 116 further includes executable instructions to compute a mix-in sample for the third MIDI data signal based on a comparison of the MIDI note velocity associated with the third MIDI data signal with either the MIDI note velocity associated with the second MIDI data signal or the MIDI note velocity value associated with the fourth MIDI data signal. In one embodiment, if the MIDI note velocities are within a predetermined range, then a mix-in sample for the third MIDI data signal is computed and the sample corresponding to the third MIDI data signal is altered as described above to generate an altered third sample. Otherwise, the third MIDI data signal is unchanged.

The synthesizer module 114 includes executable instructions to generate altered audio signals corresponding to the altered second and third samples and coordinate playback of the altered audio signals. The executable instructions in the executable modules 112, 114, 116 and 118 may be repeated for each MIDI data signal in the sequence of MIDI data signals to generate a plurality of altered audio signals, in a manner as discussed above.

Those skilled in the art will recognize a number of advantages associated with the disclosed embodiments. The disclosed embodiments develop a technique to create greater variation during the playback of similarly sounding audio signals by adding a mix-in sample to the original sample. Specifically, by mixing a percentage of the mix-in sample with a percentage of the original sample, an altered audio signal with enhanced acoustic characteristics such as resonance, timbre and tone is generated. In addition, the disclosed embodiments enable a user to graphically control the variation that can be applied to the samples via a graphical user interface, thereby allowing the generation of more natural sounding audio signals and creating enhanced user experience and satisfaction.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs, flash based media and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA, C++, or other programming language and development tools.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus comprising:
a data receiving module configured to receive a plurality of Musical Instrument Digital Interface (MIDI) data signals; and
a synthesizer module configured to analyze the plurality of MIDI data signals to generate a plurality of audio signals corresponding to the MIDI data signals, wherein the synthesizer module comprises a mix-in sample module configured to:
receive an original sample from a plurality of samples;
select a mix-in sample for the original sample;
determine a mix-in velocity percentage for the mix-in sample;
alter the original sample based on the mix-in velocity percentage to generate an altered original sample; and
generate an altered audio signal based on the altered original sample and the mix-in velocity percentage.

2. The apparatus of claim 1, wherein the mix-in sample module is configured to select the mix-in sample based on determining a velocity layer associated with the original sample.

3. The apparatus of claim 1, wherein the mix-in sample module is configured to determine the mix-in velocity percentage for the mix-in sample based on determining, a mix-in velocity range for the mix-in sample.

4. The apparatus of claim 1, wherein the mix-in sample module is configured to alter the mix-in velocity percentage based on a user-specified value to generate an altered mix-in velocity percentage.

5. The apparatus of claim 4, further comprising a user-interface module coupled to the mix-in sample module wherein the user-interface module is configured to receive, via a graphical user interface, the user-specified value.

6. The apparatus of claim 5, wherein the user-interface module is configured to display a graphical slider in the graphical user interface, and wherein the user-specified value is determined based on a particular position of the graphical slider within a range of values specified by the graphical slider.

7. The apparatus of claim 4, wherein the mix-in sample module is further configured to attenuate the original sample based on the user-specified value to generate an attenuated original sample.

8. The apparatus of claim 7, wherein the mix-in sample module is further configured to generate the altered original sample based on the attenuated original sample and the altered mix-in velocity percentage.

9. The apparatus of claim 8, wherein the mix-in sample module is further configured to generate the altered audio signal by mixing the altered original sample and the altered mix-in velocity percentage.

10. The apparatus of claim 1, wherein the data receiving module is configured to receive the plurality of MIDI data signals based on a set of MIDI data patterns and MIDI data grooves.

11. The apparatus of claim 1, wherein the synthesizer module is configured to repeat the operations to receive, select, determine, alter and generate for each sample in the plurality of samples.

12. A computer readable storage medium comprising executable instructions to:
receive a first MIDI data signal from a sequence of MIDI data signals;
receive a second MIDI data signal from the sequence of MIDI data signals;
generate a first sample based on the first MIDI signal;
generate a second sample based on the second MIDI data signal;
select a mix-in sample for the second sample, wherein the MIDI note velocity associated with the first MIDI data signal and the MIDI note velocity associated with the second MIDI data signal are within a pre-determined velocity variation range;
alter the second sample based on the mix-in sample and a user-specified value to generate an altered second sample; and
generate an altered second audio signal based on the altered second sample and the mix-in sample, wherein the altered second audio signal represents an instrument sound.

13. The computer readable storage medium of claim 12, further comprising executable instructions to:
receive a third MIDI data signal and a fourth MIDI data signal from the sequence of MIDI data signals;
generate a third sample based on the third MIDI data signal and a fourth sample based on the fourth MIDI data signal;
select a mix-in sample for the third sample based on a comparison of the MIDI note velocity associated with the third MIDI data signal with at least one of the MIDI note velocity associated with the second MIDI data signal and the MIDI note velocity associated with the fourth MIDI data signal;
alter the third sample based on the mix-in sample for the third sample and the user-specified value to generate an altered third sample; and
generate an altered third audio signal based on the altered third sample and the mix-in sample for the third sample, wherein the altered third audio signal represents an instrument sound.

14. The computer readable storage medium of claim 12, wherein the first MIDI data signal, the second MIDI data signal, the third MIDI data signal and the fourth MIDI data signal correspond to consecutive MIDI data signals in the sequence of MIDI data signals.

15. The computer readable storage medium of claim 12, wherein the executable instructions to select a mix-in sample further comprise executable instructions to determine a mix-in velocity percentage for the mix-in sample.

16. The computer readable storage medium of claim 15, wherein the executable instructions to determine the mix-in velocity percentage further comprise executable instructions to determine a mix-in velocity range for the mix-in sample.

17. The computer readable storage medium of claim 12, wherein the executable instructions to alter the second sample further comprise executable instructions to attenuate the second sample based on the user-specified value to generate an attenuated second sample.

18. The computer readable storage medium of claim 17, further comprising executable instructions to generate the altered second sample based on the attenuated second sample and the mix-in sample.

19. The computer readable storage medium of claim 18, further comprising executable instructions to mix the altered second sample and the mix-in sample to generate the altered second audio signal.

20. The computer readable storage medium of claim 12, further comprising executable instructions to repeat the operations to receive, generate, select and alter for each MIDI data signal in the sequence of MIDI data signals.

21. A computer system comprising:
a processor;
a memory connected to the processor, wherein the memory stores executable instructions to direct the processor to:
receive an original sample from a plurality of samples;
select a mix-in sample for the original sample;
determine a mix-in velocity percentage for the mix-in sample;
alter the original sample based on the mix-in velocity percentage to generate an altered original sample; and
generate an altered audio signal based on the altered original sample and the mix-in velocity percentage.

22. The computer system of claim 21, wherein the memory further stores executable instructions to direct the processor to alter the mix-in velocity percentage based on a user-specified value to generate an altered mix-in velocity percentage and generate the altered audio signal by mixing the altered original sample and the altered mix-in velocity percentage.
